(19) United States
(12) Patent Application Publication
(10) Pub. No.: US 2022/0404096 A1
(43) Pub. Date: Dec. 22, 2022

(54) METHOD AND SYSTEM FOR DRYING A MOULDING POWDER USED IN A CONFECTIONERY MOULDING PROCESS

(71) Applicant: Tanis Confectionery B.V., Oosterhout (NL)

(72) Inventor: Leonard Johannes TANIS, Oosterhout (NL)

(21) Appl. No.: 17/764,125

(22) PCT Filed: Sep. 25, 2020
(86) PCT No.: PCT/NL2020/050591

§ 371 Date: Mar. 25, 2022

(30) Foreign Application Priority Data
Sep. 25, 2019 (NL) 2023895

(51) Int. Cl. F26B 3/24; F26B 17/20; A23G 7/00; A23G 7/02

(52) U.S. Cl. CPC F26B 3/24; F26B 17/205; A23G 7/0093; A23G 7/02; B65G 33/18

(57) ABSTRACT

The invention relates to a method for drying a quantity of moulding powder, such as starch, used in a confectionery moulding process to a desired moisture content. The quantity of moulding powder is divided into at least a first fraction and a second fraction, wherein the first fraction is dried to a first moisture content and the second fraction is dried to or remains at a second moisture content, the first moisture content being lower than the second moisture content, wherein at least a portion of the dried first fraction and at least a portion of the second fraction are combined in order to obtain a resulting moulding powder having the desired moisture content. Further, the invention relates to a system for carrying out the method.

### FIELD OF THE INVENTION

The invention relates to a method and system for drying a quantity of moulding powder, such as starch, used in a confectionery moulding process to a desired moisture content.

### BACKGROUND TO THE INVENTION

Confectionery such as wine gums, gummy confections, gummy jellies, sweets/candy, etc. may have a firm structure with a softness and chewiness conferred by gelatin, starch and/or pectin based gels or other.

Typically, moulding powder is used as a forming and drying agent. A commonly used moulding powder for confectionery is starch. The confectionery can be produced by stamping desired shapes into a bed of moulding powder (e.g. starch bed) on a tray. A liquid confectionery mass is then poured into formed cavities on the bed of moulding powder. After moulding, the confectionery product can cool down and dry, optionally by air convection tunnels or chambers (conditioning rooms) in order to achieve a consistent solid matrix that matches the desired product characteristics. During this process the confectionery product can also be heated.

A portion of the moisture of the liquid confectionery is absorbed by the moulding powder. As a result, the moisture level of the moulding powder can increase after use. This moisture level of the moulding powder may become too high for use in a subsequent moulding process. Frequent replacement of the starch may be costly and time consuming. Therefore, a subsequent moulding powder drying process may be required for a (possible) re-use of the used moulding powder in a subsequent moulding process. The moulding powder can be dried (conditioning) for example by means of a fluidized bed, which can be heated to reduce the moisture level to a desired level.

The drying process of used moulding powder may require significant amount of energy. Furthermore, the drying units used for drying the moulding powder can be rather spacious in the system for moulding confectionery.

There is a need for making this drying process more efficient.

### SUMMARY OF THE INVENTION

It is an object of the invention to provide for a method and a system that obviates at least one of the above mentioned drawbacks.

Additionally or alternatively, it is an object of the invention to provide for a method and system which is more efficient in drying moulding powder used in a confectionery moulding process.

Thereto, the invention provides for a method for drying a quantity of moulding powder, such as starch, used in a confectionery moulding process, to a desired moisture content. The quantity of moulding powder is divided into at least a first fraction and a second fraction, wherein the first fraction is dried to a first moisture content and the second fraction is dried to or remains at a second moisture content, the first moisture content being lower than the second moisture content. At least a portion of the dried first fraction and at least a portion of the second fraction are combined in order to obtain a resulting moulding powder having the desired moisture content.

The moisture content of moulding powder can be reduced by performing a drying process under an increased temperature. The temperature of the moulding powder can be increased to a temperature accelerating evaporation of the liquid (cf. water) in said moulding powder. It is possible to reach an equilibrium of starch with the air surrounding the starch at higher temperature where moisture in the moulding powder can evaporate. The liquid molecules in the moulding powder need to receive sufficient heat energy to evaporate (changes from liquid state to a gaseous state). Because for drying the moulding powder needs to be heated to the evaporation temperature, it would require a lot of energy to dry the total quantity of moulding powder jointly. Instead, selectively, only a first fraction of the total quantity of moulding powder is dried, requiring significant less energy than drying the total quantity of moulding powder in a joint way. The first fraction can be dried to a lower moisture content to achieve a same dehumidification capacity. The resulting dried first fraction is (re-)combined with a second fraction of the total quantity of moulding powder to form a resulting moulding powder with a desired moisture content, the second fraction not being dried or at least less intensively being dried with respect to the first fraction. The moisture content of the resulting moulding powder may depend i.a. on the ratio of the first and second fractions, the first and second moisture content.

The amount of energy required for obtaining the desired moisture content of the resulting moulding powder can be reduced, providing significant energy benefits. Furthermore, also a smaller design can be obtained for the drying unit for drying at least the first fraction. This can result in an overall cheaper design for drying moulding powder used in a confectionery production process.

It will be clear that during production of the confectionery the confectionery is in direct contact with the moulding powder. Therefore, drying of the moulding powder must be performed in a way that food safety and quality of the confectionery is not compromised. For example, direct contact of the moulding powder, e.g. during drying, with substances that are not approved for food safety is to be avoided. Also, direct contact of the moulding powder, e.g. during drying, with substances that can compromise the quality of subsequently produced confectionery is best avoided.

Optionally, at least the first fraction is guided to a drying unit for drying it to the first moisture content, wherein the second fraction at least partially bypasses the drying unit. The moisture content of the first fraction may be reduced in the drying unit to a desired first moisture content. Depending on the moisture content of the second fraction and the quantities of the first fraction and the second fraction being combined, the moisture level of the resultant combined moulding powder including at least the first fraction and the second fraction can be determined.

The dried first fraction of molding powder may be dried such that it has a significantly lower moisture content than the remaining undried portion of the quantity of moulding powder.

Optionally, the second fraction is a remaining fraction of the quantity of moulding powder. In an example, only the first fraction is dried and the remaining second fraction is excluded from the active drying process. The second fraction may for instance bypass the drying unit used for drying the first fraction. In this way, only a selected portion on the total quantity of moulding powder is actively dried. By recombining the dried first fraction and the remaining non-dried second fraction, a resultant moulding powder is obtained with a lower moisture content than an initial moisture content of the (to be dried) quantity of moulding powder.

Optionally, the desired moisture content of the resulting moulding powder is obtained by adjusting at least one of: the first moisture content and/or the second moisture content, or a ratio of the first fraction and the second fraction combined together to obtain the resulting moulding powder.

If only the first fraction is actively dried, the resultant moisture content of the (re-)combined first fraction and second fraction can be adjusted by changing for example the first moisture content and/or the relative quantities of moulding powder in the first fraction and the second fraction. Based on the moisture content of the second fraction, i.e. the second moisture content, the moisture content of the first fraction to which it is dried can be chosen in order to obtain a desired moisture content in the resulting moulding powder obtained by combining the first fraction and the second fraction.

Optionally, the first fraction is less than 90 percent, more preferably less than 80 percent, even more preferably less than 60 percent. Sufficient energy savings can be obtained by actively drying only a limited portion of the total quantity of moulding powder. The actively dried first fraction has a significantly lower moisture content than the second fraction. By recombining the first fraction and the second fraction, a resulting moulding powder can be obtained having the desired moisture content. Since significantly less energy is required for obtaining the desired moisture content, it is possible to use more compact drying units. In this way, also the costs involved can be significantly reduced.

Optionally, the drying unit includes a heated screw conveyor with one or more screws, wherein the to be dried first fraction is guided along the one or more screws of the screw conveyor. A shaft of the screw conveyor may be heated for drying the moulding powder being guided along the one or more screws.

Heating of the screw conveyor may be carried out using a heat transfer medium which is being guided through the one or more screws. The heat transfer medium may for instance be a heated liquid or gas. It will be appreciated that other heat transfer mediums may also be used, such as for example steam.

It will be appreciated that other arrangement can also be used for drying. Optionally, the drying unit includes a fluidized bed. The moulding powder, such as starch, is normally combustible. Especially moulding powder dust, e.g. released during drying, may present an explosion hazard. Therefore, the drying unit should be configured to avoid such risks. For example, open fire is to be avoided for drying the moulding powder. The drying unit can e.g. conform to the ATEX 114 directive.

Optionally, hot air is blown into the bottom of the screw conveyor. In this way, an enhanced drying process may be obtained.

Optionally, the screw conveyor is a twin screw conveyor. Both shafts of the twin screw conveyor may be heated.

In some examples, co-rotating screws may be mounted on shafts. A closed housing (e.g. barrel) may be provided. A twin screw conveyor may be able to ensure transporting, mixing, heating, circulation, and/or cooling of the moulding powder with high level of design flexibility. Advantageously, improved mixing results may be obtained using co-rotating twin screws. In some examples, a panel is provided between two screws.

Optionally, after drying of the first fraction, at least a portion of the dried first fraction is subsequently cooled prior to combining it with at least the portion of the second fraction.

Optionally, cooling is performed in a cooling unit. Optionally, the cooling unit includes a cooled screw conveyor with one or more screws, wherein at least a portion of the dried first fraction is guided along one or more screws of the cooled screw conveyor.

Optionally, used moulding powder in a soft confectionery moulding plant is conveyed in a main stream, wherein the main stream is split into a first stream and a second stream, the first stream conveying the first fraction of moulding powder, and the second stream conveying the second fraction of the moulding powder, wherein after drying of at least the first fraction, the moulding powder in the first stream and second stream are recombined.

Optionally, moulding powder of the first stream is supplied to the drying unit and optionally a subsequent cooling unit, and wherein moulding powder of the second stream bypasses said drying unit and said optional cooling unit.

Significant energy saving can be obtained because the first stream of moulding powder is supplied to a heating unit for drying, and at least one second stream bypasses the heating unit and is thus excluded from heating for the purpose of said drying. Subsequently both streams are combined again in order to obtain a resultant moulding powder having the desired moisture level. In an example, the desired moisture content of the resultant combined moulding powder can be obtained by selecting drying conditions of the drying unit. Additionally or alternatively, the relative ratio between the first fraction and second fraction are adjusted in order to obtain the desired moisture content of the resultant combined moulding powder.

According to an aspect, the invention relates to a system including means for carrying out the method according to the invention.

According to an aspect, the invention relates to a method for drying a quantity of moulding powder, such as starch, used in a soft confectionery moulding process, wherein a fraction of the moulding powder is guided to a drying unit for obtaining a dried fraction of the moulding powder, a remaining non-dried fraction bypassing the drying unit, wherein the dried fraction of the moulding powder is added to at least a portion of the remaining non-dried fraction of the moulding powder in order to obtain a resulting moulding powder having a desired moisture content.

Advantageously, only a part of the moulding powders is guided to the drying unit such that significant energy savings can be obtained for obtaining a desired moisture content in the quantity of moulding powder.

It will be appreciated that any of the aspects, features and options described in view of the method apply equally to the system. It will also be clear that any one or more of the above aspects, features and options can be combined.

### BRIEF DESCRIPTION OF THE DRAWING

The invention will further be elucidated on the basis of exemplary embodiments which are represented in a drawing. The exemplary embodiments are given by way of non-limitative illustration. It is noted that the figures are only schematic representations of embodiments of the invention that are given by way of non-limiting example.

In the drawing:

FIG. 1 shows a schematic diagram of a process;

FIG. 2 shows a schematic diagram of a process;

FIG. 3 shows a schematic diagram of a process;

FIG. 4 shows a schematic diagram of a process;

FIG. 5 shows a schematic diagram of a process;

FIG. 6 shows a schematic diagram of a system; and

FIG. 7 shows a schematic diagram of a method.

### DETAILED DESCRIPTION

In the figures, elements having the same function and structure as those of the example shown in a different figure are given identical numerals, and a detailed explanation as to these elements will be omitted.

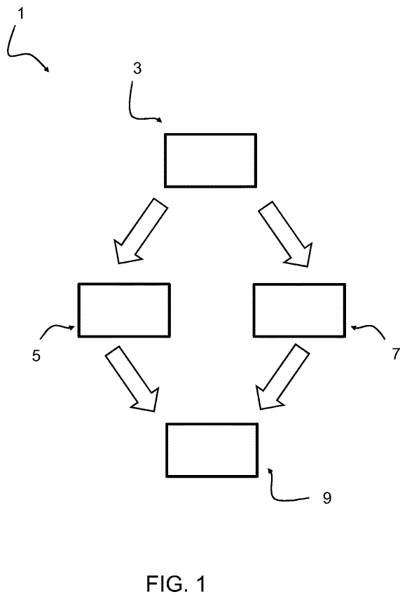

FIG. 1 shows a schematic functional diagram of a process 1. The process is used for drying a quantity of moulding powder 3 used in a confectionery moulding process to a desired moisture content. The moulding powder may for instance be starch or the like. The quantity of moulding powder 3 is divided into at least a first fraction 5 and a second fraction 7. The first fraction 5 is dried to a first moisture content and the second fraction 7 is dried to or remains at a second moisture content. The first moisture content is lower than the second moisture content. At least a portion of the dried first fraction 5 and at least a portion of the second fraction 7 are (re-)combined in order to obtain a resulting moulding powder 9 having the desired moisture content.

For thermally drying the moulding powder, first the temperature of the to be dried moulding powder can be increased to an elevated temperature resulting in accelerated and/or improved evaporation of water. Then, additional thermal energy is used for evaporation of the water (i.e. reducing moisture content). By adjusting/increasing the temperature of the starch and air around the starch an environment is created where moisture transfers to the air and a new equilibrium is reached. When the total quantity of moulding powder is being dried, the total volume of moulding powder has to be heated to the evaporating temperature prior to successive evaporation of the same water content in the moulding powder. According to the invention, only a selected portion, i.e. at least the first fraction, is heated to an evaporation temperature and subsequently dried to the first moisture content. The energy required for heating the remaining non-dried portion can be saved. Hence, the selected first fraction can be dried in a significantly more energy efficient way. In this way, the required (thermal) energy for the drying process can be considerably reduced. Moreover, a more compact drying unit may be required, so that a cheaper system may be obtained.

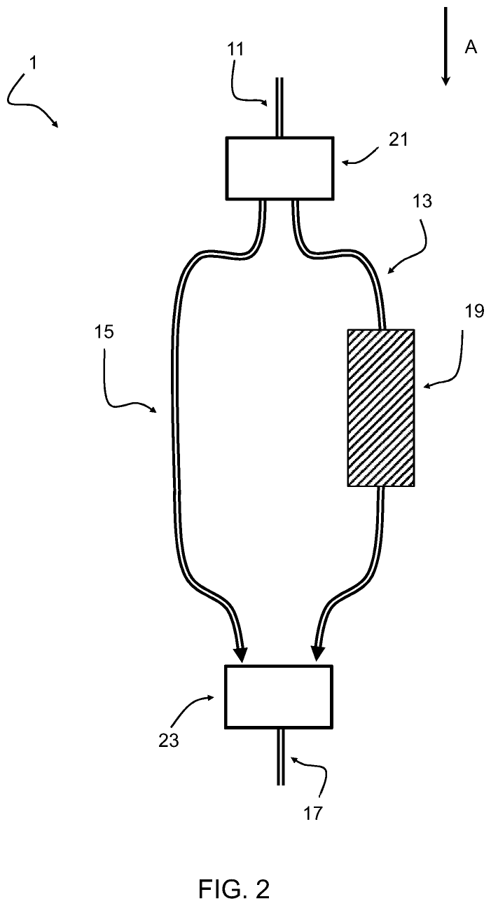

FIG. 2 shows a schematic diagram of a process 1 used for drying a quantity of moulding powder used in a confectionery moulding process to a desired moisture content. Moisture content of moulding powder (e.g. starch) can increase during the production of confectionery products. In the shown example, used moulding powder in a soft confectionery moulding process is conveyed in a main stream 11 (in a direction A). The main stream 11 is split into a first stream 13 and a second stream 15. The first stream 13 conveys the first fraction 5 of moulding powder from the main stream 11, and the second stream 15 conveying the second fraction 7 of the moulding powder of the main stream 11. After drying of the first fraction 5 in the first stream 13, the moulding powder in the first stream 13 and second stream 15 are recombined in a combined stream 17. The combined first fraction 5 and second fraction 7 result in a resultant moulding powder having lower moisture content than the moulding powder in the main stream 11. Only a portion of the moulding powder delivered by the main stream 11 is actively dried, such that a desired moisture content of moulding powder at the combined stream 17 can be obtained in a more energy efficient way. The moulding powder in the first stream 13 is dried using a drying unit 19. Since only moulding powder in the first stream 13 is to be actively dried using the drying unit 19, a smaller drying unit can be arranged. Hence, advantageously, smaller and/or more energy efficient drying units can be employed.

In the process 1 shown in FIG. 2, a divider unit 21 is arranged configured to divide a quantity of moulding powder 3 delivered via the main stream 11 into a first fraction 5 and a second fraction 7. The divider unit 21 guides the first fraction 5 to the first stream 13 and the second fraction 7 to the second stream 15. Further, a combiner unit 23 is arranged for combining the moulding powder in the first stream 13 and the second stream 15 into the combined stream 17 having the desired moisture content. The process 1 may be a continuous process, such that the steps are performed continuously. For instance the divider unit 21 may be configured to split relative quantities of the quantity of moulding powder delivered by the main stream 11 into the first and second fractions 5, 7. Alternatively, a non-continuous process (e.g. batch process) may also be employed.

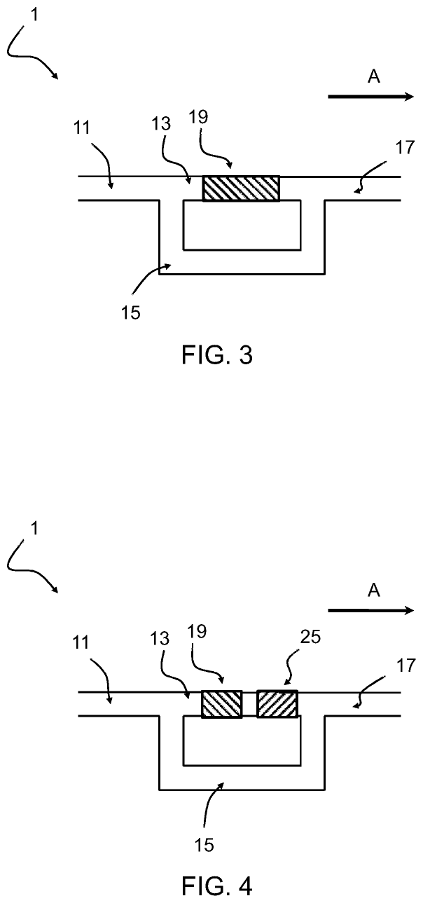

FIG. 3 shows a schematic diagram of a process 1. A quantity of moulding powder in a soft confectionery moulding process is conveyed via a main stream 11 (in a direction A). The main stream 11 is divided into a first stream 13 and a second stream 15. The first stream 13 conveys the first fraction 5 of moulding powder from the main stream 11, and the second stream 15 conveying the second fraction 7 of the moulding powder of the main stream 11. The first stream is dried using a drying unit 19. After drying of the first fraction 5 in the first stream 13, the moulding powder in the first stream 13 and second stream 15 are recombined in a combined stream 17. The combined first fraction 5 and second fraction 7 result in a resultant moulding powder having a resultant desired moisture content. Only a portion of the total moulding powder delivered by the main stream 11 is actively dried. The second stream 15 bypasses the drying unit 19. Advantageously, a desired moisture content can be obtained using significantly less energy than in a case where the total quantity of moulding powder delivered by the main stream 11 is dried.

FIG. 4 shows a schematic diagram of a process 1. Similar to the example shown in FIG. 3, only a first fraction 5 of a total quantity of moulding powder in the first stream 13 is dried using a drying unit 19 while a second fraction 7 bypasses the drying unit 19. Additionally, a cooling unit 25 is arranged in the first stream 13 after the drying unit 19. The cooling unit is configured to actively cool the dried first fraction 5 prior to combining it with the second fraction 7 in the second stream 15.

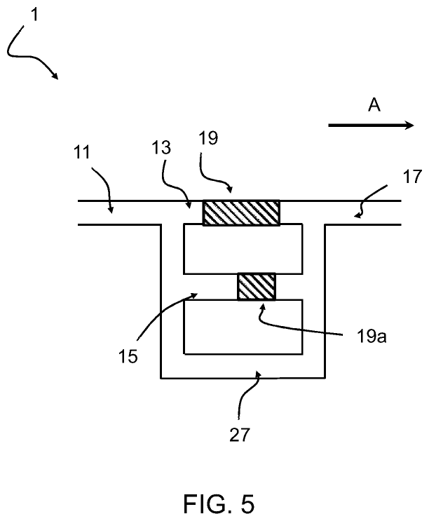

FIG. 5 shows a schematic diagram of a process 1. In this example, the main stream 11 is divided into a first stream 13, a second stream 15 and a third stream 27. The first fraction 5 of moulding powder carried in the first stream 13 is dried by means of a drying unit 19 to a first moisture content. The second fraction 7 of moulding powder carried in the second stream 15 is dried by means of a drying unit 19a to a second moisture content higher than the first moisture content. Further, a third fraction of moulding powder carried in the third stream 27 bypasses the drying units 19, 19a. A combination of the first, second and third fractions results in a moulding powder in the combined stream 17 having a resultant desired moisture content. Significantly less energy may be required to obtain the desired moisture content, since only portions of the total quantity of moulding powder are actively dried and (re-)combined with non-dried portions.

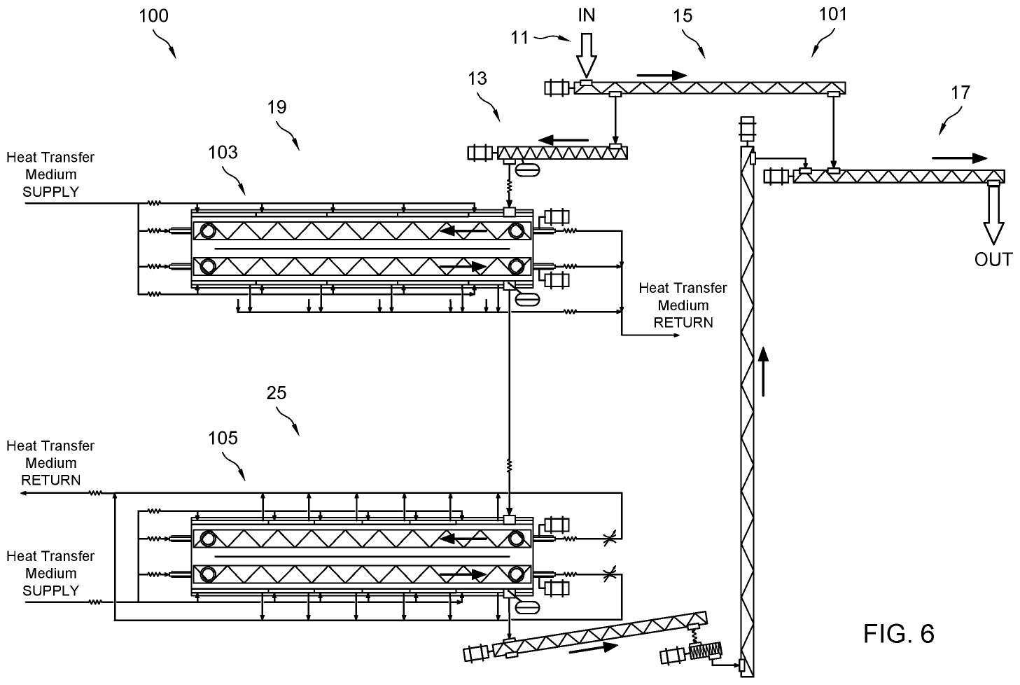

FIG. 6 shows a schematic diagram of a moulding powder conditioning system 100. The conditioning system 100 may be used for conditioning starch coming from a (soft) confectionery production process. The conditioning system 100 may be integrated in a confectionery (cf. candy) moulding system for actively at least drying a part of the moulding powder used in the confectionery moulding system. The conditioning system 100 may have additional means and/or additional functions. For instance, the conditioning system 100 may also be configured to clean the moulding powder.

In this example, the conditioning system 100 includes a moulding powder stream bypass system 101, a heating screw conveyor 103 and a cooling screw conveyor 105.

The heating screw conveyor 103 may be part of the drying unit 19. The total amount of supplied moulding powder delivered via a main stream 11 can be split up into two separate streams, namely a first stream 13 and a second stream 15. The first stream 13 carries the first fraction 5 of the total quantity of moulding powder and the second stream 15 carries a second fraction 7 of the total quantity of moulding powder. The first stream 13 is configured to enter moulding powder in the heating screw conveyor 103 and the second stream 15 is configured to bypass the heating screw conveyor 103 and the subsequent cooling screw conveyor 105. For the purpose of drying the first fraction of a total quantity of moulding powder (entering via the main stream 11), in this example a twin screw conveyor 103 is be used. Both the housing and the shafts of the screws of the heating twin screw conveyor 103 can be heated with a heat transfer medium like, but not limited to, thermal oil or steam. Moisture extracted from the moulding powder can be transferred to the air. Hot air blown into the bottom of the heating screw conveyor can be used as transfer medium for the moisture. It will be appreciated that other gasses may also be used, such as for instance N₂ gas. The residence time of the moulding powder in the heating screw conveyor can be set by regulating the filling level of the heating screw conveyor and the rotational speed of the twin screws of the heating screw conveyor 103.

After drying of the moulding powder, the heated moulding powder can be cooled down. For this purpose, also a twin screw conveyor 105 can be used. In an example, the housing and the shafts are cooled by means of a heat transfer medium like, but not limited to, cold water. A different medium can also be used. Since only the heated moulding powder coming from the heating screw conveyor 103 is cooled down in the cooling screw conveyor 105, the temperature difference of the moulding powder compared to the heat transfer medium can be relatively high resulting advantageously in more efficient cooling. The residence time of the moulding powder in the cooling screw conveyor can be set by regulating the filling level of the cooling screw conveyor and the rotational speed of the twin screws.

After the dried and cooled moulding powder leaves the cooling screw conveyor 105, the moulding powder from the bypass 101 is combined with the dried and cooled moulding powder. The combined resultant moulding powder is carried in the combined stream 17. In a subsequent moulding powder buffer, both streams can be mixed in order to obtain a homogenous moulding powder with the required final moisture content and temperature. Advantageously, a considerable amount of energy can be saved, without compromising on input or output parameters of the moulding powder. A significant energy saving can be obtained by means of the arrangement of the system 100, since only a portion of the starch needs to be heated (to slightly higher temperature). The system 100 is more energy efficient and allows a high level of control over the desired process conditions for obtained the desired resultant moulding powder with reduced moisture content. The drying conditions may be accurately controlled in order to obtain the desired predetermined resultant moisture content.

In some examples, a fluidized bed is used for drying the starch. The starch can be heated up to an elevated temperature (e.g. 50 degrees Celsius) with hot air as heating medium. The outgoing hot air may therefore have at least the elevated temperature (e.g. 50 degrees Celsius). In some embodiments, heat is recovered from this hot air.

In some examples, heating can be achieved using a medium (e.g. oil) at an elevated temperature (e.g. 140 degrees Celsius). The medium can cool down as a result of the drying process of the moulding powder (e.g. from 140 degrees Celsius to 130 degrees Celsius), requiring additional heating for maintaining the elevated temperature. It is also possible that the medium/oil is heated for compensating for temperature drops.

It will be appreciated that the cooling step is optional and can be omitted in the drying process. Furthermore, other types of drying units can also be used instead of a heated screw conveyor type.

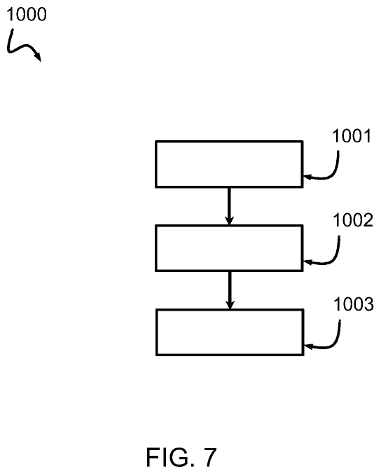

FIG. 7 shows a schematic diagram of a method 1000 for drying a quantity of moulding powder, such as starch, used in a confectionery moulding process to a desired moisture content. In a first step 1001, the quantity of moulding powder is divided into at least a first fraction and a second fraction. In a second step 1002, the first fraction is dried to a first moisture content and the second fraction is dried to or remains at a second moisture content, the first moisture content being lower than the second moisture content. In a third step 1003, at least a portion of the dried first fraction and at least a portion of the second fraction are combined in order to obtain a resulting moulding powder having the desired moisture content.

To be dried moulding powder (e.g. starch) from a candy production process may be divided into at least a first stream and a second stream. The first stream may be actively dried while the second stream is excluded from active drying. The two streams can then be mixed again so that a resultant moulding powder is obtained having a desired moisture content.

Although the terms “first” and “second” may be used herein to describe various features/elements, these features/elements should not be limited by these terms, unless the context indicates otherwise. These terms may be used to distinguish one feature/element from another feature/element. Thus, a first feature/element discussed below could be termed a second feature/element, and similarly, a second feature/element discussed below could be termed a first feature/element without departing from the teachings of the present invention.

Elements from one embodiment may be added to another embodiment. For example, orders of processes described herein may be changed and are not limited to the manner described herein. Moreover, the actions in any flow diagram need not be implemented in the order shown; nor do all of the acts necessarily need to be performed. Also, those acts that are not dependent on other acts may be performed in parallel with the other acts. Numerous variations, whether explicitly given in the specification or not, such as differences in structure, dimension, and use of material, are possible.

Herein, the invention is described with reference to specific examples of embodiments of the invention. It will, however, be evident that various modifications, variations, alternatives and changes may be made therein, without departing from the essence of the invention. For the purpose of clarity and a concise description features are described herein as part of the same or separate embodiments, however, alternative embodiments having combinations of all or some of the features described in these separate embodiments are also envisaged and understood to fall within the framework of the invention as outlined by the claims. The specifications, figures and examples are, accordingly, to be regarded in an illustrative sense rather than in a restrictive sense. The invention is intended to embrace all alternatives, modifications and variations which fall within the spirit and scope of the appended claims. Further, many of the elements that are described are functional entities that may be implemented as discrete or distributed components or in conjunction with other components, in any suitable combination and location.

In the claims, any reference signs placed between parentheses shall not be construed as limiting the claim. The word ‘comprising’ does not exclude the presence of other features or steps than those listed in a claim. Furthermore, the words ‘a’ and ‘an’ shall not be construed as limited to ‘only one’, but instead are used to mean ‘at least one’, and do not exclude a plurality. The mere fact that certain measures are recited in mutually different claims does not indicate that a combination of these measures cannot be used to an advantage.

1. A method for drying a quantity of moulding powder used in a confectionery moulding process to a desired moisture content, wherein the quantity of moulding powder is divided into at least a first fraction and a second fraction, wherein the first fraction is dried to a first moisture content and the second fraction is dried to or remains at a second moisture content, the first moisture content being lower than the second moisture content, wherein at least a portion of the dried first fraction and at least a portion of the second fraction are combined in order to obtain a resulting moulding powder having the desired moisture content.

2. The method according to claim 1, wherein at least the first fraction is guided to a drying unit for drying it to the first moisture content, and wherein the second fraction at least partially bypasses the drying unit.

3. The method according to claim 1, wherein the second fraction is a remaining fraction of the quantity of moulding powder.

4. The method according to claim 1, wherein the desired moisture content of the resulting moulding powder is obtained by adjusting at least one of:
the first moisture content and/or the second moisture content, or
a ratio of the first fraction and the second fraction combined together to obtain the resulting moulding powder.

5. The method according to claim 1, wherein the first fraction is less than 90 percent.

6. The method according to claim 1, wherein the drying unit includes a heated screw conveyor with one or more screws, wherein the to be dried first fraction is guided along the one or more screws of the screw conveyor.

7. The method according to claim 6, wherein the screw conveyor is a twin screw conveyor.

8. The method according to claim 1, wherein after drying of the first fraction, at least a portion of the dried first fraction is cooled prior to combining it with at least the portion of the second fraction.

9. The method according to claim 8, wherein cooling is performed in a cooling unit.

10. The method according to claim 9, wherein the cooling unit includes a cooled screw conveyor with one or more screws, wherein at least a portion of the dried first fraction is guided along one or more screws of the cooled screw conveyor.

11. The method according to claim 1, wherein used moulding powder in a soft confectionery moulding plant is conveyed in a main stream, wherein the main stream is split into a first stream and a second stream, the first stream conveying the first fraction of moulding powder, and the second stream conveying the second fraction of the moulding powder, wherein after drying of at least the first fraction, the moulding powder in the first stream and second stream are recombined.

12. A system for performing the method according to claim 1 comprising:
means for dividing the quantity of moulding powder into at least a first fraction and a second fraction,
means for drying the first fraction to a first moisture content,
means for drying the second fraction to a second moisture content,
wherein the first moisture content is lower than the second moisture content, and
means for combining at least a portion of the dried first fraction and at least a portion of the second fraction to provide a resulting moulding powder having the desired moisture content.
